(19) United States
(12) Patent Application Publication
(10) Pub. No.: US 2018/0132044 A1
(43) Pub. Date: May 10, 2018

(54) Hearing aid with camera

(71) Applicant: BRAGI GmbH, München (DE)

(72) Inventor: Peter Vincent Boesen, München (DE)

(73) Assignee: BRAGI GmbH, München (DE)

(21) Appl. No.: 15/794,748

(22) Filed: Oct. 26, 2017

Related U.S. Application Data
(60) Provisional application No. 62/417,791, filed on Nov. 4, 2016.

(51) Int. Cl. H04R 25/00; H04R 25/02

(52) U.S. Cl. CPC H04R 25/50; H04R 25/02; H04B 1/3827; H04R 2225/43; G06T 2207/30004; H04R 25/65

(57) ABSTRACT

A hearing aid includes a housing, a processor, one or more microphones, a speaker, and a camera. A method of processing sound using a hearing aid includes receiving the sound at a microphone operatively connected to the hearing aid, receiving at least one reading from a camera operatively connected to the hearing aid, processing the sound in accordance with at least one function using one or more readings from the camera to create a processed sound, and producing the processed sound at a speaker operatively connected to the hearing aid.

### RELATED APPLICATIONS

This application claims priority to U.S. Provisional Application No. 62/417,791, entitled “Hearing aid with camera” and filed on Nov. 4, 2016, hereby incorporated by reference in its entirety.

### FIELD OF THE INVENTION

The present invention relates hearing aids.

### BACKGROUND

Hearing aids are very useful to people who have hearing difficulties. One issue related to hearing aids is that a user may encounter an unexpected or unanticipated situation in which the functionality of the hearing aid may need to be modified in order to maximize the use and enjoyment of the hearing aid. One potential way of solving this problem is by using a camera operatively connected to the hearing aid. What is needed is a system and method of processing sound in a hearing aid using imagery from a camera.

### SUMMARY

Therefore, it is a primary object, feature, or advantage of the present invention to improve over the state of the art.

It is a further object, feature, or advantage of the present invention to integrate a camera with a hearing aid.

It is a further object, feature, or advantage of the present invention to use camera imagery to modify one or more sounds received by a hearing aid.

It is a still further object, feature, or advantage of the present invention to produce one or more sounds modified in accordance with camera imagery.

Another object, feature, or advantage is to store camera imagery within a hearing aid for later use.

In one implementation, a hearing aid includes a housing, a processor disposed within the housing, one or more microphones operatively connected to the processor and the housing, a speaker operatively connected to the processor and the housing, and a camera operatively connected to the processor and the housing, wherein sounds received by the at least one microphone are processed by the processor in accordance with one or more functions executed by the processor using an analysis of imagery provided by the camera. One or more of the following features may be included. One or more functions or settings may include user communication or sound modification. The imagery taken by the camera may be images or videos.

In another implementation, a hearing aid includes a housing, a processor disposed within the housing, one or more microphones operatively connected to the processor and the housing, a memory device disposed within the housing and operatively connected to the processor, one or more transceivers disposed within the housing and operatively connected to the processor, one or more sensors operatively connected to the housing and the processor, a speaker operatively connected to the processor and the housing, and a camera operatively connected to the processor and the housing, wherein sounds received by the at least one microphone are processed by the processor in accordance with at least one function executed by the processor using imagery provided by the camera. One or more of the following features may be included. One of the sensors may be a bone conduction sensor, an air conduction sensor, a pressure sensor, or an inertial sensor. One or more functions may include user communication settings or sound modification settings. The imagery taken by the camera may be images or videos.

In another implementation, a method of processing sound using a hearing aid includes receiving the sound at a microphone operatively connected to the hearing aid, receiving imagery from a camera operatively connected to the hearing aid, processing the sound in accordance with at least one function determined based on image analysis of imagery from the camera to create a processed sound, and producing the processed sound at a speaker operatively connected to the hearing aid. One or more of the following features may be included. One of the sensors may be a bone conduction sensor, an air conduction sensor, a pressure sensor, or an inertial sensor. The bone conduction sensor may be proximate to a user's temporal bone to receive internal sounds to be used by the processor in accordance with one or more functions. One or more functions may comprise user communication or sound modification including particular sound modifications for particular types of environments or types of user communications. The imagery taken by the camera may be images or videos.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an object, feature, or advantage stated herein.

### BRIEF DESCRIPTION OF THE DRAWINGS

FIG. 1 shows a block diagram of one embodiment of a hearing aid.

FIG. 2 shows a block diagram of another embodiment of the hearing aid.

FIG. 3 illustrates a pair of hearing aids.

FIG. 4 illustrates a side view of a hearing aid in an ear.

FIG. 5 illustrates a hearing aid and its relationship to a mobile device.

FIG. 6 illustrates a hearing aid and its relationship to a network.

FIG. 7 illustrates a method of processing sound using a hearing aid.

### DETAILED DESCRIPTION

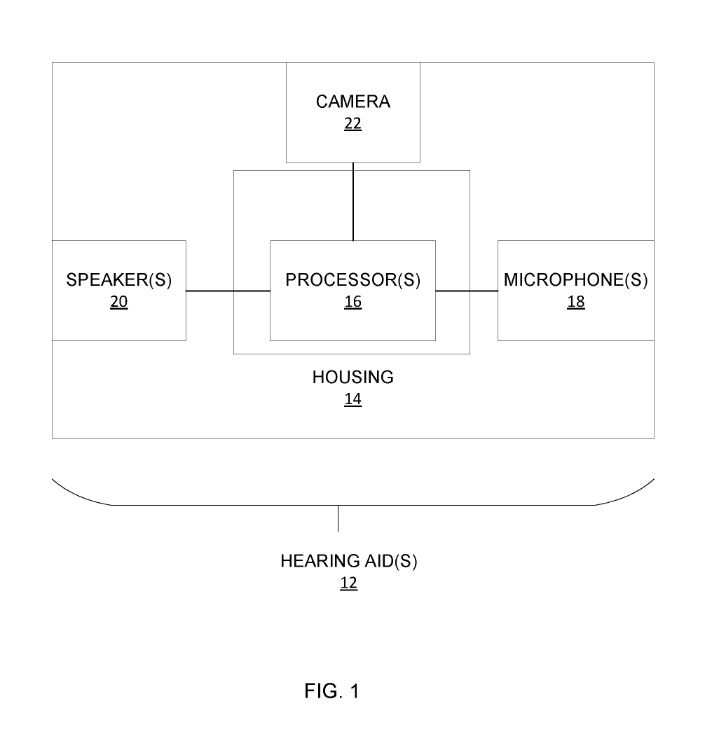

FIG. 1 shows a block diagram of one embodiment of a hearing aid 12. The hearing aid 12 contains a housing 14, a processor 16 operatively connected to the housing 14, at least one microphone 18 operatively connected to the housing 14 and the processor 16, a speaker 20 operatively connected to the housing 14 and the processor 16, and a camera 22 operatively connected to the housing 14 and the processor 16, wherein sounds received by one or more of the microphones 18 are processed in accordance with imagery from the camera 22. Each of the aforementioned components may be arranged in any manner suitable to implement the hearing aid.

The housing 14 may be composed of plastic, metallic, nonmetallic, or any material or combination of materials having substantial deformation resistance in order to facilitate energy transfer if a sudden force is applied to the hearing aid 12. For example, if the hearing aid 12 is dropped by a user, the housing 14 may transfer the energy received from the surface impact throughout the entire hearing aid. In addition, the housing 14 may be capable of a degree of flexibility in order to facilitate energy absorbance if one or more forces is applied to the hearing aid 12. For example, if an object is dropped on the hearing aid 12, the housing 14 may bend in order to absorb the energy from the impact so that the components within the hearing aid 12 are not substantially damaged. The flexibility of the housing 14 should not, however, be flexible to the point where one or more components of the earpiece may become dislodged or otherwise rendered non-functional if one or more forces is applied to the hearing aid 12.

In addition, the housing 14 may be configured to be worn in any manner suitable to the needs or desires of the hearing aid user. For example, the housing 14 may be configured to be worn behind the ear (BTE), wherein each of the components of the hearing aid 12, with the exception of the speaker 20, rest behind the ear. The speaker 20 may be operatively connected to an earmold and connected to the other components of the hearing aid 12 by a connecting element. The speaker 20 may also be positioned to maximize the communications of sounds to the inner ear of the user. In addition, the housing 14 may be configured as an in-the-ear (ITE) hearing aid, which may be fitted on, at, or within (such as an in-the canal (ITC) or invisible-in-canal (IIC) hearing aid) an external auditory canal of a user. The housing 14 may additionally be configured to either completely occlude the external auditory canal or provide one or more conduits in which ambient sounds may travel to the user's inner ear.

One or more microphones 18 may be operatively connected to the housing 14 and the processor 16 and may be configured to receive sounds from the outside environment, one or more third or outside parties, or even from the user. One or more of the microphones 18 may be directional, bidirectional, or omnidirectional, and each of the microphones may be arranged in any configuration conducive to alleviating a user's hearing loss or difficulty. In addition, each microphone 18 may comprise an amplifier configured to amplify sounds received by a microphone by either a fixed factor or in accordance with one or more user settings of an algorithm stored within a memory device or the processor of the hearing aid 12. For example, if a user has special difficulty hearing high frequencies, a user may instruct the hearing aid 12 to amplify higher frequencies received by one or more of the microphones 18 by a greater percentage than lower or middle frequencies. The user may set the amplification of the microphones 18 using a voice command received by one of the microphones 18, a control panel or gestural interface on the hearing aid 12 itself, or a software application stored on an external electronic device such as a mobile phone or a tablet. Such settings may also be programmed by a factory or hearing professional. Sounds may also be amplified by an amplifier separate from the microphones 18 before being communicated to the processor 16 for sound processing.

One or more speakers 20 may be operatively connected to the housing 14 and the processor 16 and may be configured to produce sounds derived from signals communicated by the processor 16. The sounds produced by the speakers 20 may be ambient sounds, speech from a third party, speech from the user, media stored within a memory device of the hearing aid 12 or received from an outside source, information stored in the hearing aid 12 or received from an outside source, or a combination of one or more of the foregoing, and the sounds may be amplified, attenuated, or otherwise modified forms of the sounds originally received by the hearing aid 12. For example, the processor 16 may execute a program to remove background noise from sounds received by the microphones 18 in order to make a third party voice within the sounds more audible, which may then be amplified or attenuated before being produced by one or more of the speakers 20. The speakers 20 may be positioned proximate to an outer opening of an external auditory canal of the user or may even be positioned proximate to a tympanic membrane of the user for users with moderate to severe hearing loss. In addition, one or more speakers 20 may be positioned proximate to a temporal bone of a user in order to conduct sound for people with limited hearing or complete hearing loss. Such positioning may even include anchoring the hearing aid 12 to the temporal bone.

A camera 22 may be operatively connected to the housing 14 and the processor 16 and may be configured to capture images or record video of the surrounding environment. The camera 22 may be positioned anywhere on the housing 14 conducive to capturing images or recording video. The images or video may be stored within a memory device operatively connected to the camera itself or a memory device operatively connected to the hearing aid 12. Images captured by the camera 22 may be stored in raster formats such as JPEG, TIFF, GIF, BMP, or PNG, vector formats such as AI or EPS, compound formats such as EPS, PDF, SWF, or PostScript, or other suitable formats. Videos recorded by the camera 22 may be stored in container formats such as AVI, WMV, MOV, MP4, FLV, or other container formats. The container formats may comprise any number of video coding and audio coding formats as well. The camera 22 may be controlled using a voice command received by one of the microphones 18, a control panel or gestural interface on the hearing aid 12 itself, or a software application stored on an external electronic device such as a mobile phone or a tablet.

The processor 16 may be disposed within the housing 14 and operatively connected to each component of the hearing aid 12 and may be configured to process sounds received by one or more microphones 18 in accordance with a video or image file recorded or captured by the camera 22. The video or image file may comprise environmental or identity information which may be used to filter certain sounds the user may or may not wish to hear. For example, if the user desires to initiate or join a conversation with one or more persons, the user may instruct the hearing aid 12 using a voice command or a gesture to filter non-verbal sounds if the camera captures an image or records a video comprising one or more individuals. The non-verbal sounds may be filtered using an algorithm executed by the processor 16 which may be stored in a memory device operatively connected to the camera 22, a memory device operatively connected to the hearing aid 12, or the processor 16, wherein the algorithm may filter the non-verbal sounds by comparing a waveform or waveform decomposition of one or more sounds received by a microphone 18 and a waveform or waveform decomposition profile of verbal sounds stored in a memory device and only processing sounds that substantially match the verbal sound waveform or waveform decomposition profiles stored in a memory device. The processor 16 may also apply one or more algorithms to neutralize sounds originating from the body or other sounds that may be communicated to a user during an interaction with one or more individuals using destructive interference techniques. In addition, videos or images recorded or captured by the camera 22 may be used to filter, amplify, or attenuate one or more sounds when entering certain areas. For example, if a user enters an area which is likely to be noisy, such as an event at a stadium, the camera 22 may capture an image or record a video of the user's environment which may be subsequently compared to data or information related to stadium events stored in a memory device, which may prompt the processor 16 to execute an algorithm to either reduce the volume of the sounds produced by the speakers 20 or attenuate one or more of the noises or sounds received via one or more microphones 18 in order to reduce the likelihood of hearing damage if the video or image comprises elements indicative of a noisy environment. Whether an image or video comprises elements indicative of a noisy environment may be determined by comparing data or metadata derived from the image or video with data or metadata stored in a memory device operatively connected to the camera 22 or the hearing aid 12 using an algorithm executed by the processor 16 in order to determine whether the data or metadata derived from the image or video substantially match data or metadata in a memory device determined to be indicative of a noisy environment. The processor 16 may also filter out sounds with amplitudes in excess of a certain amount or may even amplify certain low frequency or low amplitude sounds if desired by a user. The processor 16 may also employ additional algorithms to modify sounds as well.

Thus, it should be understood that images or video may be processed to provide additional contextual information which may be used to assist in changing hearing aid settings or modes of operation. Any number of different algorithms may be used for processing the imagery including applying feature extraction and machine learning models, applying deep learning models such as convolutional neural networks (CNNs), applying bag-of-words models, applying gradient-based and derivative-based matching approaches, applying the Viola-Jones algorithm, using template matching, and performing image segmentation and blob analysis.

Examples of contextual analysis may include identifying whether a small number or large number of people are present, identifying whether the user is inside or outside, identifying a specific type of location such as a stadium, restaurant, movie theatre, or otherwise. Particular sound processing settings may be implemented based on the particular environment or particular type of noise sources or otherwise. These settings may specify amplification, amplification for different frequencies, amplification for sound from different microphones where the hearing aid has more than one microphone, or other types of settings which may applied to sound processing.

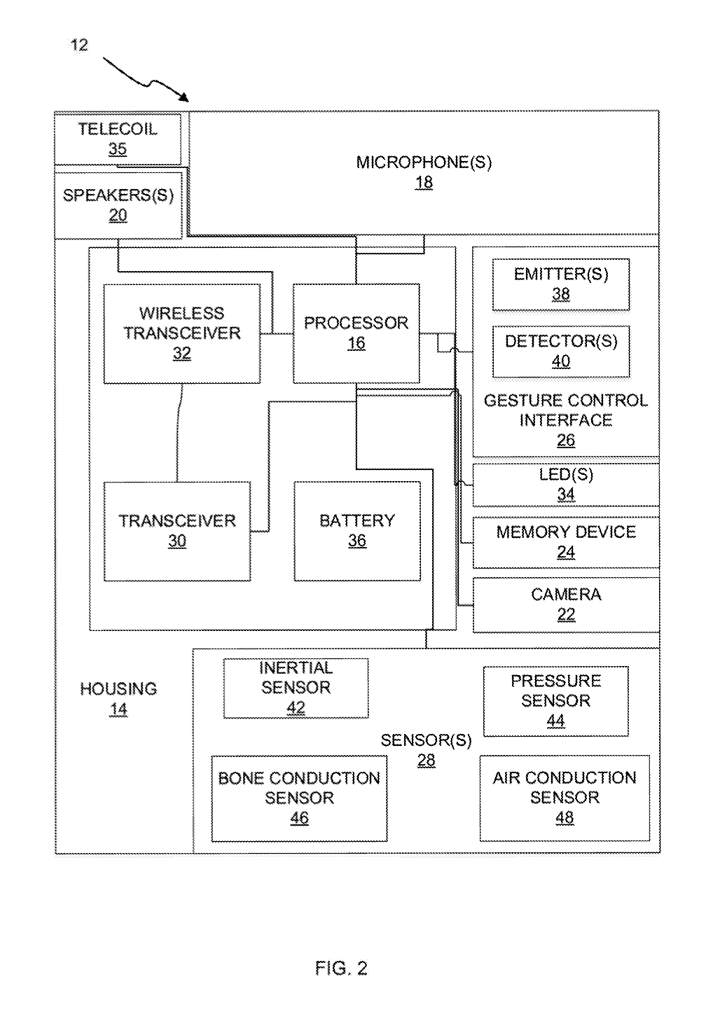

FIG. 2 illustrates a second embodiment of the hearing aid 12. In addition to the elements described in FIG. 1, the hearing aid 12 may further comprise a memory device 24 operatively connected to the housing 14 and the processor 16, a gestural interface 26 operatively connected to the housing 14 and the processor 16, a sensor 28 operatively connected to the housing 14 and the processor 16, a transceiver 30 disposed within the housing 14 and operatively connected to the processor 16, a wireless transceiver 32 disposed within the housing 14 and operatively connected to the processor 16, one or more LEDs 34 operatively connected to the housing 14 and the processor 16, and a battery 36 disposed within the housing 14 and operatively connected to each component within the hearing aid 12. The housing 14, processor 16, microphones 18, speaker 20, and camera 22 function substantially the same as described in FIG. 1 above, with differences in regards to the additional components as described below.

Memory device 24 may be operatively connected to the housing 14 and the processor 16 and may be configured to store images captured by or video recorded by the camera 22. In addition, the memory device 24 may also store information related to the images captured or video recorded by the camera 22 including algorithms related to data analysis regarding the images captured or video recorded by the camera 22 or data or metadata derived from images or video captured by the camera 22. In addition, the memory device 24 may store data or information regarding other components of the hearing aid 12. For example, the memory device 24 may store data or information encoded in signals received from the transceiver 30 or wireless transceiver 32, data or information regarding sensor readings from one or more sensors 28, algorithms governing command protocols related to the gesture interface 26, or algorithms governing LED 34 protocols. The aforementioned list is non-exclusive.

Gesture interface 26 may be operatively connected to the housing 14 and the processor 16 and may be configured to allow a user to control one or more functions of the hearing aid 12. The gesture interface 26 may include at least one emitter 38 and at least one detector 40 to detect gestures from either the user, a third-party, an instrument, or a combination of the aforementioned and communicate one or more signals representing the gesture to the processor 16. The gestures that may be used with the gesture interface 26 to control the hearing aid 12 include, without limitation, touching, tapping, swiping, use of an instrument, or any combination of the aforementioned gestures. Touching gestures used to control the hearing aid 12 may be of any duration and may include the touching of areas that are not part of the gesture control interface 26. Tapping gestures used to control the hearing aid 12 may include any number of taps and need not be brief. Swiping gestures used to control the hearing aid 12 may include a single swipe, a swipe that changes direction at least once, a swipe with a time delay, a plurality of swipes, or any combination of the aforementioned. An instrument used to control the hearing aid 12 may be electronic, biochemical or mechanical, and may interface with the gesture interface 26 either physically or electromagnetically.

One or more sensors 28 having an inertial sensor 42, a pressure sensor 44, a bone conduction sensor 46 and an air conduction sensor 48 may be operatively connected to the housing 14 and the processor 16 and may be configured to sense one or more user actions. The inertial sensor 42 may sense a user motion which may be used to modify a sound received at a microphone 18 to be communicated at a speaker 20. For example, a MEMS gyroscope, an electronic magnetometer, or an electronic accelerometer may sense a head motion of a user, which may be communicated to the processor 16 to be used to make one or more modifications to a sound received at a microphone 18 in accordance with an image or video captured by the camera 22 and subsequently communicated via the speaker 20 to the user. The pressure sensor 44 may be used to make adjustments to one or more sounds received by one or more of the microphones 18 depending on the air pressure conditions at the hearing aid 12. In addition, the bone conduction sensor 46 and the air conduction sensor 48 may be used in conjunction to sense unwanted sounds and communicate the unwanted sounds to the processor 16 in order to improve audio transparency. For example, the bone conduction sensor 46, which may be positioned proximate a temporal bone of a user, may receive an unwanted sound faster than the air conduction sensor 48 due to the fact that sound travels faster through most physical media than air and subsequently communicate the sound to the processor 16, which may apply a destructive interference noise cancellation algorithm to the unwanted sounds if substantially similar sounds are received by either the air conduction sensor 48 or one or more of the microphones 18. If not, the processor 16 may cease execution of the noise cancellation algorithm, as the noise likely emanates from the user, which the user may want to hear, though the function may be modified by the user.

Transceiver 30 may be disposed within the housing 14 and operatively connected to the processor 16 and may be configured to send or receive signals from another hearing aid if the user is wearing a hearing aid 12 in both ears. The transceiver 30 may receive or transmit more than one signal simultaneously. For example, a transceiver 30 in a hearing aid 12 worn at a right ear may transmit a signal encoding temporal data used to synchronize sound output with a hearing aid 12 worn at a left ear. The transceiver 30 may be of any number of types including a near field magnetic induction (NFMI) transceiver.

Wireless transceiver 32 may be disposed within the housing 14 and operatively connected to the processor 16 and may receive signals from or transmit signals to another electronic device. The signals received from or transmitted by the wireless transceiver 32 may encode data or information related to media or information related to news, current events, or entertainment, information related to the health of a user or a third party, information regarding the location of a user or third party, or the functioning of the hearing aid 12. For example, if a user expects to encounter a problem or issue with the hearing aid 12 due to an event the user becomes aware of while listening to a weather report using the hearing aid 12, the user may instruct the hearing aid 12 to communicate instructions regarding how to transmit a signal encoding the user's location and hearing status to a nearby audiologist or hearing aid specialist in order to rectify the problem or issue. More than one signal may be received from or transmitted by the wireless transceiver 32.

LEDs 34 may be operatively connected to the housing 14 and the processor 16 and may be configured to provide information concerning the earpiece. For example, the processor 16 may communicate a signal encoding information related to the current time, the battery life of the earpiece, the status of another operation of the earpiece, or another earpiece function to the LEDs 34 which decode and display the information encoded in the signals. For example, the processor 16 may communicate a signal encoding the status of the energy level of the earpiece, wherein the energy level may be decoded by LEDs 34 as a blinking light, wherein a green light may represent a substantial level of battery life, a yellow light may represent an intermediate level of battery life, and a red light may represent a limited amount of battery life, and a blinking red light may represent a critical level of battery life requiring immediate recharging. In addition, the battery life may be represented by the LEDs 34 as a percentage of battery life remaining or may be represented by an energy bar having one or more LEDs, wherein the number of illuminated LEDs represents the amount of battery life remaining in the earpiece. The LEDs 34 may be located in any area on the hearing aid suitable for viewing by the user or a third party and may also consist of as few as one diode which may be provided in combination with a light guide. In addition, the LEDs 34 need not have a minimum luminescence.

Telecoil 35 may be operatively connected to the housing 14 and the processor 16 and may be configured to receive magnetic signals from a communications device in lieu of receiving sound through a microphone 18. For example, a user may instruct the hearing aid 12 using a voice command received via a microphone 18, providing a gesture to the gesture interface 26, or using a mobile device to cease reception of sounds at the microphones 18 and receive magnetic signals via the telecoil 35. The magnetic signals may be further decoded by the processor 16 and produced by the speakers 20. The magnetic signals may encode media or information the user desires to listen to.

Battery 36 is operatively connected to all of the components within the hearing aid 12. The battery 36 may provide enough power to operate the hearing aid 12 for a reasonable duration of time. The battery 36 may be of any type suitable for powering the hearing aid 12. However, the battery 36 need not be present in the hearing aid 12. Alternative battery-less power sources, such as sensors configured to receive energy from radio waves (all of which are operatively connected to one or more hearing aids 12) may be used to power the hearing aid 12 in lieu of a battery 36.

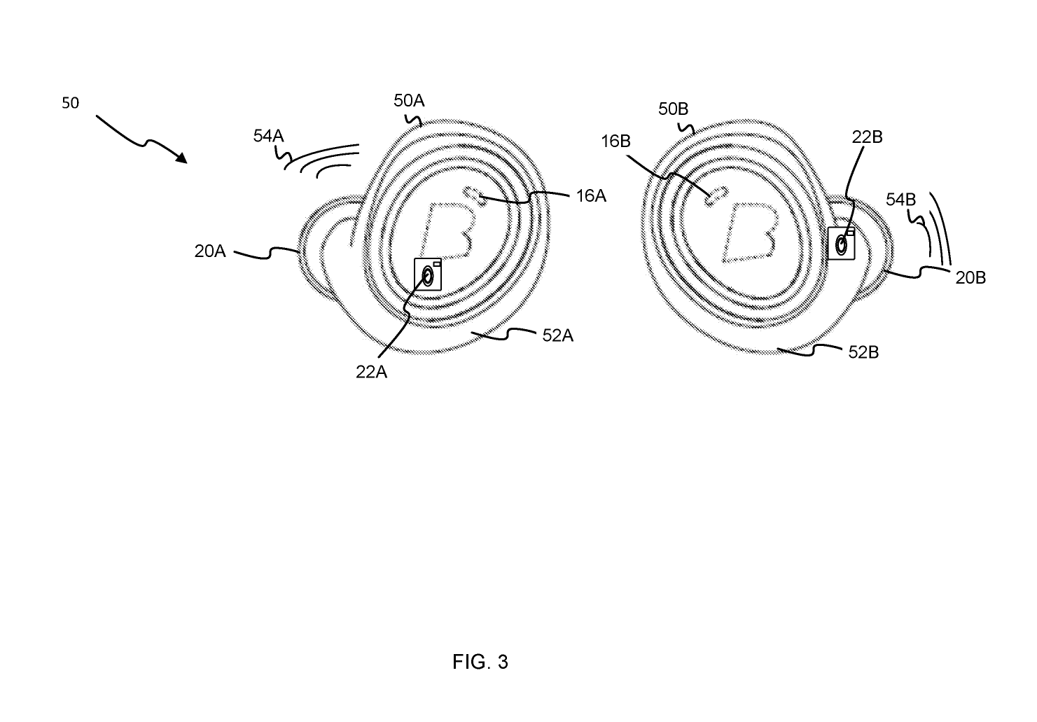

FIG. 3 illustrates a pair of hearing aids 50 which includes a left hearing aid 50A and a right hearing aid 50B. The left hearing aid 50A has a left housing 52A. The right hearing aid 50B has a right housing 52B. The left hearing aid 50A and the right hearing aid 50B may be configured to fit on, at, or within a user's external auditory canal and may be configured to substantially minimize or completely eliminate external sound capable of reaching the tympanic membrane. The housings 52A and 52B may be composed of any material with substantial deformation resistance and may also be configured to be soundproof or waterproof. A microphone 18A is shown on the left hearing aid 50A and a microphone 18B is shown on the right hearing aid 50B. The microphones 18A and 18B may be located anywhere on the left hearing aid 50A and the right hearing aid 50B respectively and each microphone may be configured to receive one or more sounds from the user, one or more third parties, or one or more sounds, either natural or artificial, from the environment. Speakers 20A and 20B may be configured to communicate processed sounds 54A and 54B. The processed sounds 54A and 54B may be communicated to the user, a third party, or another entity capable of receiving the communicated sounds. Speakers 20A and 20B may also be configured to short out if the decibel level of the processed sounds 54A and 54B exceeds a certain decibel threshold, which may be preset or programmed by the user or a third party. A camera 22A is shown on the left hearing aid 50A and a camera 22B is shown on the right hearing aid 50B. Cameras 22A and 22B may be configured to capture images or record video from the surrounding environment. The images and videos may be captured or recorded continuously until the hearing aids run out of storage memory or periodically in response to one or more user commands or an algorithm stored in the processors of the hearing aids. The images or videos may be used in conjunction with sounds received by microphones 18A and 18B to amplify, attenuate, or otherwise modify one or more sounds received by the microphones.

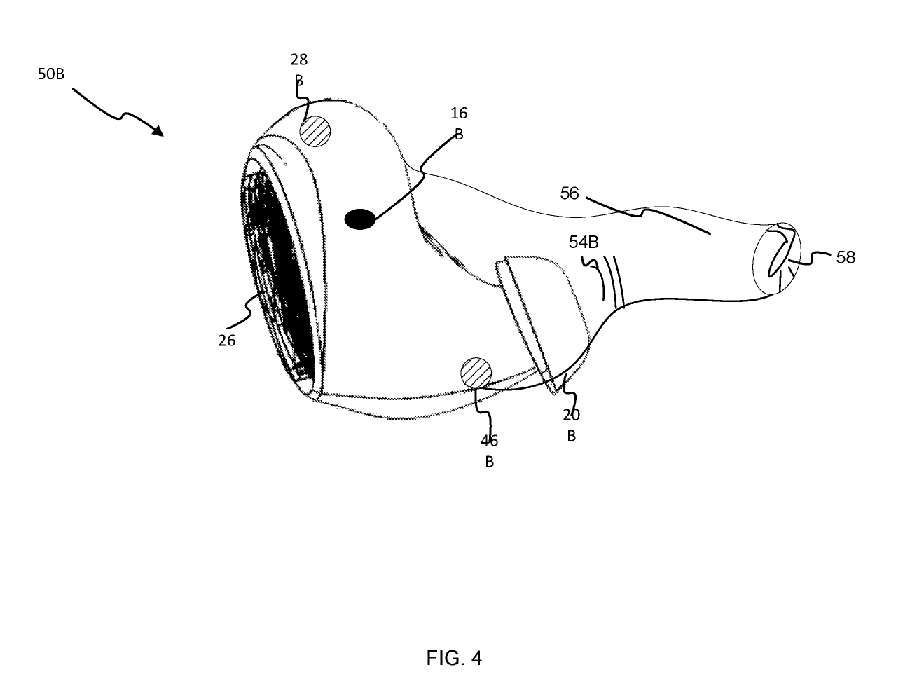

FIG. 4 illustrates a side view of the right hearing aid 50B and its relationship to a user's ear. The right hearing aid 50B may be configured to both minimize the amount of external sound reaching the user's external auditory canal 56 and to facilitate the transmission of the processed sound 54B from the speaker 20 to a user's tympanic membrane 58. The right hearing aid 50B may also be configured to be of any size necessary to comfortably fit within the user's external auditory canal 56 and the distance between the speaker 20B and the user's tympanic membrane 58 may be any distance sufficient to facilitate transmission of the processed sound 54B to the user's tympanic membrane 58. Camera 22B may be placed on the side of the right hearing aid 50B and may capture images or record video that may be used in conjunction with videos or images captured by camera 22A (not shown) to amplify, attenuate, or otherwise modify one or more sounds that are to be produced by speaker 20B (or 20A if necessary). There is a gesture interface 26B shown on the exterior of the earpiece. The gesture interface 26B may provide for gesture control by the user or a third party such as by tapping or swiping across the gesture interface 26B, tapping or swiping across another portion of the right hearing aid 50B, providing a gesture not involving the touching of the gesture interface 26B or another part of the right hearing aid 50B, or through the use of an instrument configured to interact with the gesture interface 26B. In addition, one or more sensors 28B may be positioned on the right hearing aid 50B to allow for sensing of user motions unrelated to gestures. For example, one sensor 28B may be positioned on the right hearing aid 50B to detect a head movement which may be used to modify one or more sounds received by the microphone 18B in order to minimize sound loss or remove unwanted sounds that may be received due to the head movement. Another sensor 28B, which may comprise a bone conduction microphone 46B, may be positioned near the temporal bone of the user's skull in order to sense a sound from a part of the user's body or to sense one or more sounds before the sounds reach one of the microphones due to the fact that sound travels much faster through bone and tissue than air. For example, the bone conduction microphone 46B may sense a random sound traveling along the ground the user is standing on and communicate the random sound to processor 16B, which may instruct one or more microphones 18B to filter the random sound out before the random sound traveling through the air reaches any of the microphones 18B. More than one random sound may be involved. The aforementioned operation may also be used in adaptive sound filtering techniques in addition to preventative filtering techniques.

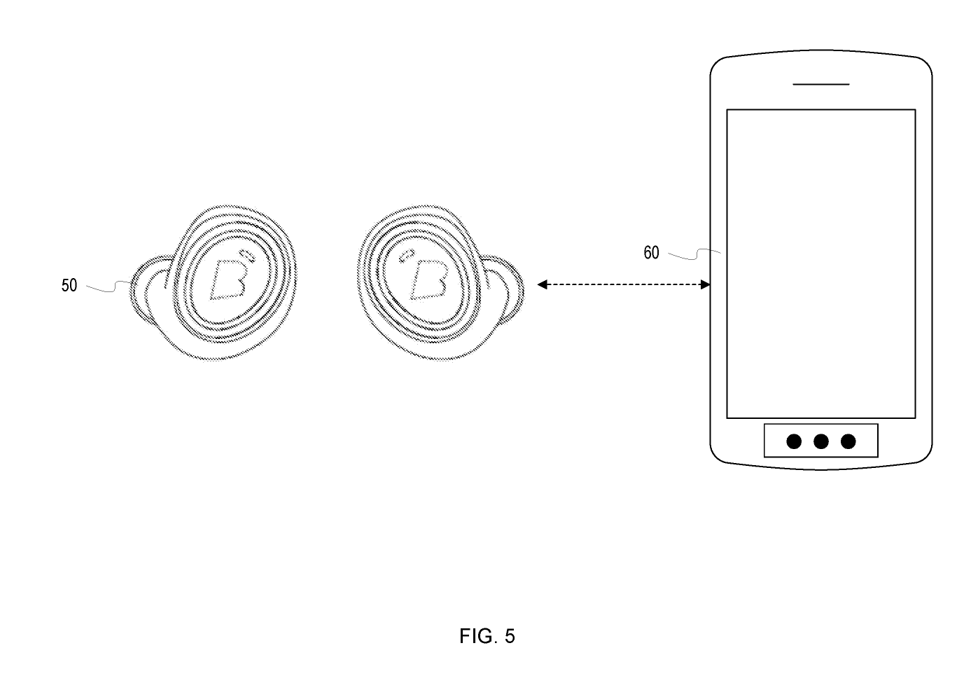

FIG. 5 illustrates a pair of hearing aids 50 and their relationship to a mobile device 60. The mobile device 60 may be a mobile phone, a tablet, a watch, a PDA, a remote, an eyepiece, an earpiece, or any electronic device not requiring a fixed location. The user may use a software application on the mobile device 60 to select, control, change, or modify one or more functions of the hearing aid. For example, the user may use a software application on the mobile device 60 to access a screen providing one or more choices related to the functioning of the hearing aid pair 50, including volume control, pitch control, sound filtering, media playback, or other functions a hearing aid wearer may find useful. Selections by the user or a third party may be communicated via a transceiver in the mobile device 60 to the pair of hearing aids 50. The software application may also be used to access a hearing profile related to the user, which may include certain directions in which the user has hearing difficulties or sound frequencies that the user has difficulty hearing. In addition, the mobile device 60 may also be a remote that wirelessly transmits signals derived from manual selections provided by the user or a third party on the remote to the pair of hearing aids 50. In addition, the hearing aids 50 may receive signals encoding data related to images captured by or video recorded by one or more cameras operatively connected to the pair of hearing aids 50 for use with the software application, hearing analysis, or use by a third party such as an audiologist.

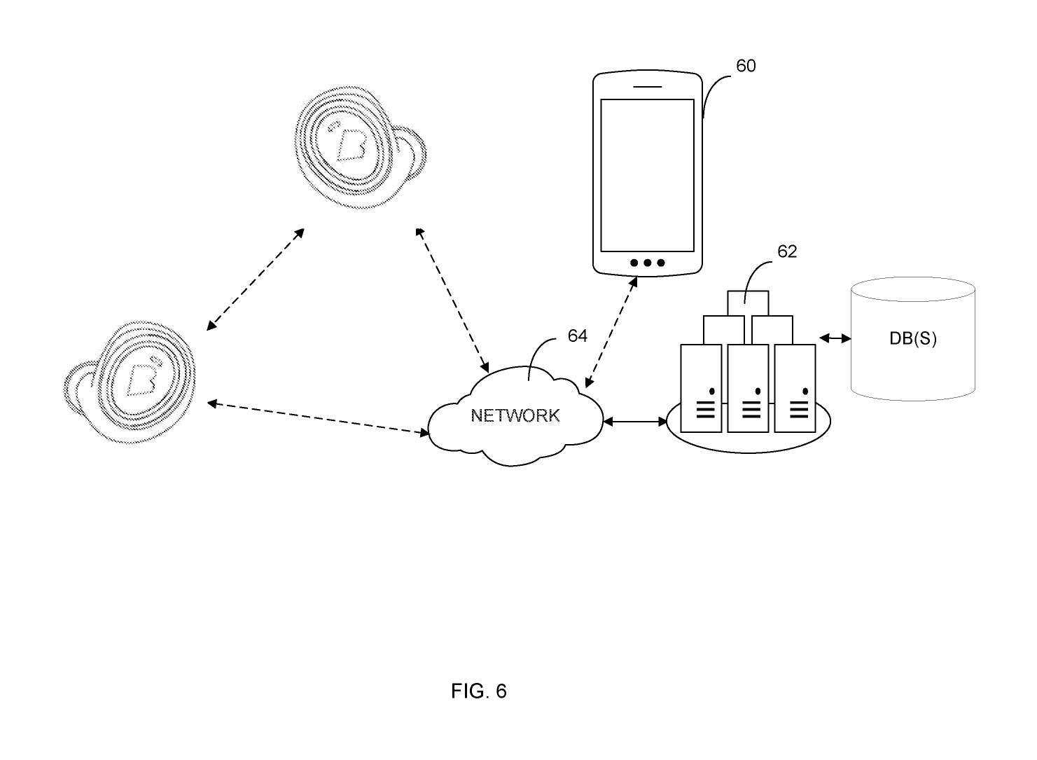

FIG. 6 illustrates a pair of hearing aids 50 and their relationship to a network. Hearing aid pair 50 may be connected to a mobile phone 60, another hearing aid, or one or more data servers 62 through a network 64 and the hearing aid pair 50 may be simultaneously connected to more than one of the foregoing devices. The network 64 may be the Internet, a Local Area Network, or a Wide Area Network, and the network 64 may comprise one or more routers, one or more communications towers, or one or more Wi-Fi hotspots, and signals transmitted from or received by one of the hearing aids of hearing aid pair 50 may travel through one or more devices connected to the network 64 before reaching their intended destination. For example, if a user wishes to upload information concerning the user's hearing to an audiologist or hearing clinic, which may include one or more images, one or more videos, or data or metadata related to an image or video captured by a camera (e.g. 22A or 22B) operatively connected to one of the hearing aids 50, the user may instruct hearing aid 50A, 50B or mobile device 60 to transmit a signal encoding data, including images and videos, related to the user's hearing to the audiologist or hearing clinic, which may travel through a communications tower or one or more routers before arriving at the audiologist or hearing clinic. The audiologist or hearing clinic may subsequently transmit a signal signifying that the file was received to the hearing aid pair 50 after receiving the signal from the user. In addition, the user may use a telecoil within the hearing aid pair 50 to access a magnetic signal created by a communication device in lieu of receiving a sound via a microphone. The telecoil may be accessed using a gesture interface, a voice command received by a microphone, or using a mobile device to turn the telecoil function on or off.

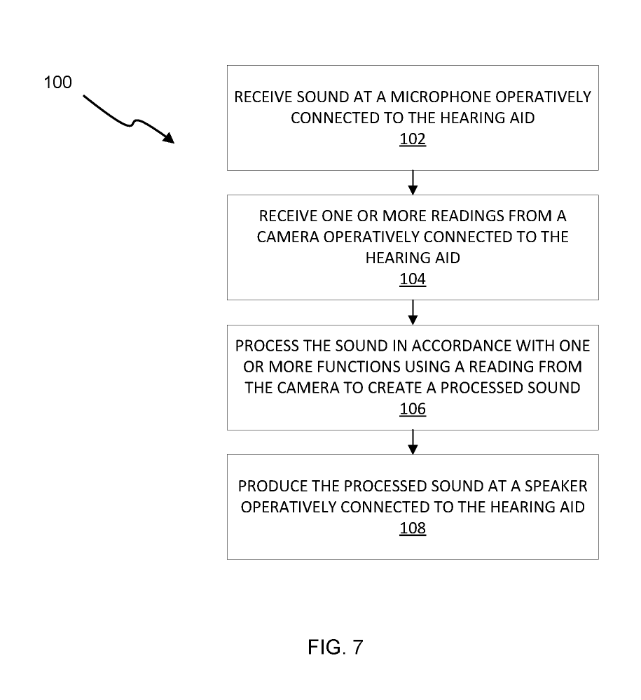

FIG. 7 illustrates a flowchart of a method of processing sound using a hearing aid 100. First, in step 102, one or more sounds are received by one or more microphones operatively connected to the hearing aid. The sounds may originate from a user of the hearing aid, a third-party, or from the environment, wherein the environmental sounds may be natural or artificial, and the sounds may be received continuously or intermittently. In step 104, a camera operatively connected to the hearing aid receives imagery. The imagery may comprise an image or a video, and the image or video may be related to one or more persons, one or more animals, one or more objects, one or more entities, the environment, or a combination of one or more of the foregoing, and the list is non-exclusive. In step 106, a processor disposed within the hearing aid processes the sounds received by the microphones in accordance with one or more functions using imagery taken by the camera to create one or more processed sounds. Functions related to the sound processing may be preset or set by the user or a third party. For example, sound processing by the processor may be in accordance with a desire of the user to converse with a third party, wherein the data derived from camera imagery may be used by the processor to filter out all sounds unrelated to the third party's voice. In addition, sound processing by the processor may also be in accordance with a preset function or a function set by the user or a third party to attenuate a sound if a video recorded by the camera or an image captured by the camera contains data related to construction machinery or equipment, as the sounds in the environment may be very loud and risk damaging the user's hearing. The processor may also attenuate, amplify, or otherwise modify a sound in accordance with a hearing profile of the user which may be stored in a memory device disposed within or operatively connected to the hearing aid. For example, if the user has difficulty hearing low frequency noises, the processor may execute an algorithm to amplify sounds below a frequency suggested by the user's hearing profile. In step 108, the processed sounds are produced by a speaker operatively connected to the hearing aid. The speaker may be positioned proximate a tympanic membrane, proximate the inner surface of an external auditory canal, or proximate the surface of a temporal bone in order to conduct the sounds via the skull for users who have extreme difficulty hearing. The speaker may also short out if the processed sounds have a sufficiently large amplitude or have a sufficiency high frequency that risks damaging the tympanic membrane.

What is claimed is:

1. A hearing aid comprising:
a housing;
a processor disposed within the housing;
at least one microphone operatively connected to the processor and the housing;
a speaker operatively connected to the processor and the housing; and
a camera operatively connected to the processor and the housing;
wherein sounds received by the at least one microphone are processed by the processor in accordance with at least one function executed by the processor based on an analysis of imagery provided by the camera.

2. The hearing aid of claim 1 wherein the at least one function comprises user communication.

3. The hearing aid of claim 1 wherein the at least one function comprises sound modification.

4. The hearing aid of claim 1 wherein the imagery comprises a static image.

5. The hearing aid of claim 1 wherein the imagery comprises video imagery.

6. A hearing aid comprising:
a housing;
a processor disposed within the housing;
at least one microphone operatively connected to the processor and the housing;
a memory device disposed within the housing and operatively connected to the processor;
at least one transceiver disposed within the housing and operatively connected to the processor;
at least one sensor operatively connected to the housing and the processor;
a speaker operatively connected to the processor and the housing; and
a camera operatively connected to the processor and the housing;
wherein sounds received by the at least one microphone are processed by the processor in accordance with at least one function executed by the processor based on an analysis of imagery provided by the camera.

7. The hearing aid of claim 6 wherein the at least one sensor further comprises an air conduction sensor, a bone conduction sensor, an inertial sensor, or a pressure sensor.

8. The hearing aid of claim 6 wherein the at least one microphone further comprises a directional microphone.

9. The hearing aid of claim 6 wherein the at least one function comprises user communication.

10. The hearing aid of claim 6 wherein the at least one function comprises sound modification.

11. The hearing aid of claim 6 wherein the imagery is a static image.

12. The hearing aid of claim 6 wherein the imagery comprises video imagery.

13. A method of processing sound using a hearing aid comprising:
receiving the sound at a microphone of the hearing aid;
receiving imagery from a camera of the hearing aid;
analyzing imagery from the camera to determine at least one setting for processing the sound;
processing the sound in accordance with the at least one setting to create a processed sound; and
producing the processed sound at a speaker operatively of the hearing aid.

14. The method of claim 13 wherein the at least one setting comprises a user communication setting.

15. The method of claim 13 wherein the at least one setting comprises sound modification.
